(19) United States
(12) Patent Application Publication
(10) Pub. No.: US 2014/0144839 A1
(43) Pub. Date: May 29, 2014

(54) APPARATUS AND METHOD FOR CULTIVATING MICROALGAE USING EFFLUENT FROM SLUDGE TREATMENT

(71) Applicant: KOREA INSTITUTE OF SCIENCE AND TECHNOLOGY, Seoul (KR)

(72) Inventors: Yong Su Choi, Seoul (KR); Kyu Won Seo, Seoul (KR); Jae Shik Chung, Seoul (KR); Seok Won Hong, Seoul (KR); Gyobeom Kim, Seoul (KR)

(73) Assignee: KOREA INSTITUTE OF SCIENCE AND TECHNOLOGY, Seoul (KR)

(21) Appl. No.: 14/043,246

(22) Filed: Oct. 1, 2013

(30) Foreign Application Priority Data
Nov. 28, 2012 (KR) 10-2012-0136033

(51) Int. Cl. C02F 3/02

(52) U.S. Cl. CPC C02F 3/02
USPC 210/620; 210/195.2

(57) ABSTRACT

Disclosed herein are an apparatus and method for cultivating microalgae using effluent from sludge treatment. The apparatus includes an advanced sewage treatment apparatus, a sludge treatment apparatus and a microalgae cultivation apparatus, the sludge treatment apparatus including: a first aerobic reactor which is operated under aerobic conditions and serves to ferment sludge; a second aerobic reactor which is operated in a state in which air is injected in an amount larger than that in the first aerobic reactor, and serves to increase the fermentation activity of microorganisms in the sludge and degrade the sludge; a membrane bio-reactor (MBR) which serves to receive effluent from the second aerobic reactor and biologically remove high-concentration organic matter from the effluent by the action of aerobic microorganisms while removing total suspended solids using a membrane, wherein the effluent discharged from the MBR reactor is supplied to the microalgae cultivation apparatus.

### CROSS-REFERENCE TO RELATED APPLICATION

This application claims priority to Korean Patent Application No. 10-2012-136033, filed on Nov. 28, 2012, and all the benefits accruing therefrom under 35 U.S.C. §119, the contents of which in its entirety are herein incorporated by reference.

### BACKGROUND

1. Field

The present disclosure relates to an apparatus and method for cultivating microalgae using effluent from sludge treatment, and more particularly to an apparatus and method for cultivating microalgae using effluent from sludge treatment, in which a combination of an advanced sewage treatment process, a sludge treatment process and a microalgae cultivation process is used so that a high-concentration nitrate nitrogen-containing effluent discharged from the sludge treatment process is used for the cultivation of microalgae while the discharge of excess sludge can be minimized by performing the sludge treatment process under aerobic conditions using microbial fermentation.

2. Description of the Prior Art

In recent years, in connection with reducing carbon dioxide emissions to alleviate global warming caused by carbon dioxide emissions, microalgae have been of increasing interest. Microalgae biologically fix carbon dioxide by photosynthesis and use carbon dioxide as an energy source, and biomass resulting from the growth of microalgae is highly useful as animal feed, a raw material for bioenergy, etc. In addition, the nitrogen and phosphorus contained in livestock excretions are used for the cultivation of microalgae without artificially supplying nitrogen and phosphorus, eutrophication can be alleviated.

Thus, there have been attempts to cultivate microalgae using sewage/wastewater as media. For example, Korean Patent Laid-Open Publication No. 2003-76133 and 2003-95154 disclose the development of microalgae cultivation media using livestock excretions. In addition, with respect to technologies for treating sewage/wastewater using microalgae, Korean Patent Laid-Open Publication No. 2006-100869 discloses a movable floating contact media module and an apparatus and method for purifying water using the same, and Korean Patent Laid-Open Publication No. 2005-0024728 discloses a method for improving water quality in rural watersheds using a periphytic algal system.

The above technologies suggest a microalgae cultivation process connected with a sewage/waste treatment process, but have problems in that, because they are based on the anaerobic treatment of livestock excretions or sewage/wastewater, the reduction of sludge is limited, and in that additional apparatuses are required for sludge treatment.

### SUMMARY

Accordingly, the present disclosure has been made in view of the problems occurring in the prior art, and it is an object of the present disclosure to provide an apparatus and method for cultivating microalgae using effluent from sludge treatment, in which a combination of an advanced sewage treatment process, a sludge treatment process and a microalgae cultivation process is used so that a high-concentration nitrate nitrogen-containing effluent discharged from the sludge treatment process is used for the cultivation of microalgae while the discharge of excess sludge can be minimized by performing the sludge treatment process under aerobic conditions using microbial fermentation.

To achieve the above object, the present disclosure provides an apparatus for cultivating microalgae using effluent from sludge treatment, the apparatus including an advanced sewage treatment apparatus, a sludge treatment apparatus and a microalgae cultivation apparatus, the sludge treatment apparatus including: a first aerobic reactor which is operated under aerobic conditions and serves to reduce the activity of microorganisms in sludge and ferment the sludge by the fermentation of the microorganisms; a second aerobic reactor which is operated in a state in which air is injected in an amount larger than that in the first aerobic reactor, and serves to increase the fermentation activity of the microorganisms and degrade the sludge; and a membrane bio-reactor (MBR) which serves to receive effluent from the second aerobic reactor and biologically remove high-concentration organic matter from the effluent by the action of aerobic microorganisms while removing total suspended solids using a membrane, wherein the effluent from the second aerobic reactor is separated into concentrated sludge and effluent in the MBR reactor, the effluent from the MBR is supplied to the microalgae cultivation apparatus, the concentrated sludge is returned to the second aerobic reactor, and the concentration of nitrate nitrogen increases in the order of the first aerobic reactor, the second aerobic reactor and the MBR reactor.

The microalgae cultivation apparatus includes a microalgae cultivation reactor and a microalgae membrane, in which the microalgae cultivation reactor serves to cultivate microalgae using, as nutrient, the effluent from the MBR reactor of the sludge treatment apparatus, and the microalgae membrane serves to water in the microalgae cultivation reactor into microalgae and treated water.

The advanced sewage treatment apparatus includes: an anaerobic reactor serving to remove phosphorus (P) from influent water while denitrifying nitrite nitrogen and nitrate nitrogen; a first intermittent aeration reactor and a second intermittent aeration reactor, which are operated under different conditions (aerobic conditions and oxygen-free conditions), serve to convert organic nitrogen and ammonia nitrogen to nitrite nitrogen and nitrate nitrogen under aerobic conditions while allowing phosphorus in influent water to be taken by phosphorus-storing microorganisms, and serve to reduce nitrite nitrogen and nitrate nitrogen into nitrogen gas under oxygen-free conditions; and a first ceramic membrane and a second ceramic membrane, which are provided in the lower portions of the first intermittent aeration reactor and the second intermittent reactor, respectively, and serve to produce treated water, wherein the first intermittent aeration reactor and the second intermittent aeration reactor are operated under different conditions, influent water discharged from the anaerobic reactor is supplied to one of the first intermittent aeration reactor and the second intermittent aeration reactor, which is operated under aerobic conditions, and when the first intermittent aeration reactor is under aerobic conditions and the second intermittent aeration reactor is under oxygen-free conditions, air is injected into the first intermittent aeration reactor through the first ceramic membrane to maintain the first intermittent aeration reactor in aerobic conditions while treated water is discharged to the outside through the second ceramic membrane, and sludge in the second intermittent aeration reactor is supplied to the aeration reactor of the sludge treatment apparatus.

Each of the first ceramic membrane and the second ceramic membrane is provided with an air injection line and a treated-water discharge line, in which the air injection line serves to inject air into the first ceramic membrane or the second ceramic membrane, and the treated-water discharge line serves to discharge treated water produced by the first ceramic membrane or the second ceramic membrane to the outside.

When the first intermittent aeration reactor or the second intermittent aeration reactor is under aerobic conditions, air is injected into the first ceramic membrane or the second ceramic membrane through the air injection line while the treated-water discharge line is blocked, and when the first intermittent aeration reactor or the second intermittent aeration reactor is under oxygen-free conditions, the injection of air through the air injection line is blocked while treated water produced by the first ceramic membrane or the second ceramic membrane is discharged to the outside.

A method for cultivating microalgae using effluent from sludge treatment includes: performing an advanced sewage treatment process using an advanced sewage treatment apparatus; supplying sludge, accumulated in the advanced sewage treatment process, to a first aerobic reactor of a sludge treatment apparatus, and fermenting the slurry under aerobic conditions; aerobically operating a second aerobic reactor while injecting air in an amount larger to than that in the first aerobic reactor to increase the fermentation activity of microorganisms in the sludge and degrade the sludge; degrading the sludge discharged from the second aerobic reactor using an MBR reactor while separating the sludge into concentrated sludge and effluent; and culturing microalgae using the effluent discharged from the MBR reactor, wherein the concentration of nitrate nitrogen increases in the order of the first aerobic reactor, the second aerobic reactor and the MBR reactor.

The apparatus for cultivating microalgae using effluent from sludge treatment according to the present disclosure has the following effects.

It is possible to increase the efficiency with which microalgae are cultivated, because microalgae are cultivated using effluent containing a high concentration of nitrate nitrogen. In addition, the discharge of sludge can be minimized, because the sludge is treated by aerobic digestion.

### BRIEF DESCRIPTION OF THE DRAWINGS

FIG. 1 shows the configuration of an apparatus for cultivating microalgae using effluent from sludge treatment according to an embodiment of the present disclosure.

FIG. 2 shows the configuration of an advanced sewage treatment apparatus according to the present disclosure.

FIGS. 3A to 3C are graphs showing the concentrations of nitrate nitrogen in a first aerobic tank, a second aerobic tank and an MBR tank.

FIG. 4 is a graphic diagram showing a comparison between the amount of microalgae cultivated according to the present disclosure and the amount of microalgae cultivated using conventional media.

### DETAILED DESCRIPTION

The present disclosure is directed to technology for cultivating microalgae using effluent discharged from a sludge treatment process connected with an advanced sewage treatment process and a microalgae cultivation process. The sludge treatment process is characterized in that it is based on the aerobic digestion of sludge so that the discharge of sludge is minimized and effluent from the sludge treatment process contains a high concentration of nitrate nitrogen, thereby increasing the efficiency with which microalgae are cultivated.

In addition, the advanced sewage treatment process is characterized in that a first intermittent aeration tank and a second intermittent aeration tank are sequentially disposed, and each of the first intermittent aeration tank and the second intermittent aeration tank is operated alternately under aerobic conditions and oxygen-free conditions so that the influent water is treated under both aerobic conditions and oxygen-free conditions, thereby maximizing the efficiency with which nitrogen and phosphorus are removed. Hereinafter, an apparatus for cultivating microalgae using effluent from sludge treatment according to an embodiment of the present disclosure will be described in detail with reference to the accompanying drawings.

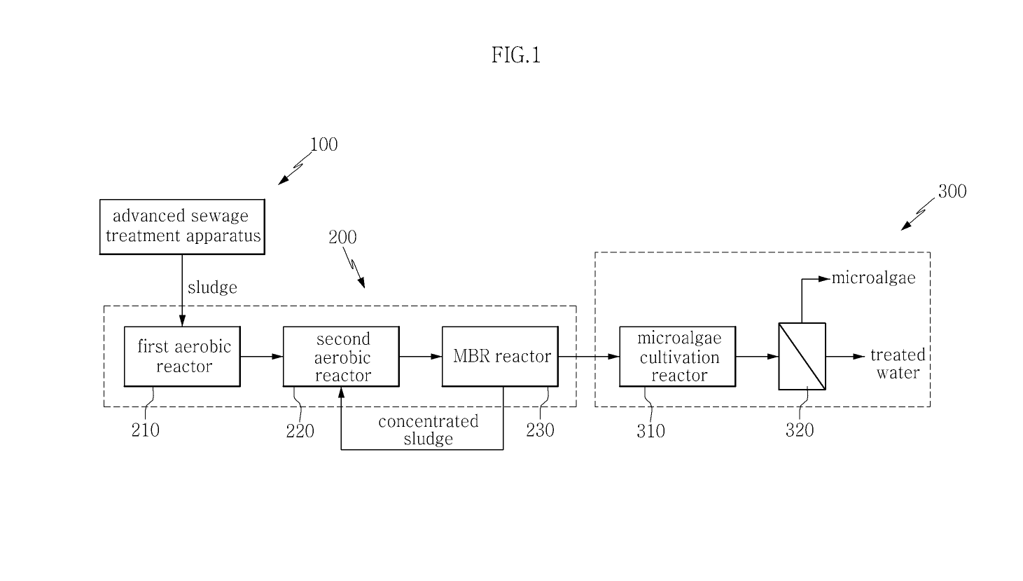

Referring to FIG. 1, an apparatus for cultivating microalgae using effluent from sludge treatment according to an embodiment of the present disclosure is generally composed of an advanced sewage treatment apparatus 100, a sludge treatment apparatus 200 and a microalgae cultivation apparatus 300. The advanced sewage treatment apparatus 100 serves to remove nutrients such as nitrogen and phosphorus from sewage/wastewater and finally separate the sewage/wastewater into treated water and sludge. The sludge treatment apparatus 200 serves to receive the sludge separated in the advanced sewage treatment apparatus 100 and aerobically digest the sludge by microbial fermentation to thereby reduce the sludge while discharging an effluent containing a high concentration of nitrate nitrogen. The microalgae cultivation apparatus 300 serves to cultivate microalgae using as nutrient the high-concentration nitrate nitrogen-containing effluent discharged from the sludge treatment apparatus 200 and separate the grown microalgae.

First, the configuration of the sludge treatment apparatus 200 will be described. The sludge treatment apparatus 200 comprises a first aerobic reactor 210, a second aerobic reactor 220 and a membrane bio-reactor (MBR) 230. The first aerobic reactor 210 and the second aerobic reactor 220 serve to aerobically digest sludge by microbial fermentation to degrade organic matter in the sludge so as to reduce microbial activity to thereby degrade and reduce the sludge and increase the concentration of nitrate nitrogen in the sludge. A microbial solution is supplied to the first aerobic tank. The microbial solution contains various microorganisms, typical examples of which include Lactobacillus, Acetobacter, Acinetobacter, etc.

The first aerobic reactor 210 and the second aerobic reactor 220 are all operated under aerobic conditions, but the amount of air supplied into the second aerobic reactor 220 is larger than that in the first aerobic reactor 210, and thus the amount of dissolved oxygen in the second aerobic reactor 220 is larger than that in the first aerobic reactor 210. In the first aerobic reactor 210, the activity of microorganisms in sludge is reduced, and in the second aerobic reactor 220, the fermentation activity of the microorganisms is increased, and thus the degradation of organic matter, that is, the degradation of sludge, is accelerated. In order to reduce microbial activity in the first aerobic reactor 210 and degrade sludge in the second aerobic reactor 220, the amount of air injected into the second aerobic reactor 220 should be about 1.5-2 times larger than that in the first aerobic reactor 210.

In other words, the first aerobic tank 210 serves as a fermentation reactor, and the second aerobic reactor 220 serves as a liquefaction reactor. In the first aerobic reactor 210, the activity of microorganisms is reduced, and thus fermentation by aerobic digestion occurs, and in the second aerobic reactor 220, the fermentation activity of microorganisms is increased due to the increase in the amount of dissolved oxygen, and thus the degradation of organic matter (i.e., sludge) occurs, resulting in liquefaction of the sludge.

In the above process, the supernatant in the first aerobic tank 210 is supplied to the second aerobic reactor 220, and each of the first aerobic tank 210 and the second aerobic tank 220 can be partitioned into three regions in order to increase fermentation efficiency and sludge degradation efficiency. In this case, the supernatant in each region moves to a region adjacent thereto.

Meanwhile, when organic matter (i.e.,) is degraded, organic materials are released from the organic matter. The degradation of organic matter in the second aerobic reactor 220 is supported by experimental results. As can be seen in Table 1 below, the amounts of inorganic materials in the effluent from the second aerobic reactor 220 are increased compared to those in the effluent from the first aerobic reactor 210, suggesting that the degradation of sludge in the second aerobic reactor 220 is accelerated. In addition, it can be seen that the degradation of sludge in the MBR reactor 230 as described below is increased compared to that in the second aerobic reactor 220.

TABLE 1
Analysis of organic materials in effluents from first aerobic
reactor 210, second aerobic reactor 220 and MBR reactor 230

| | First aerobic | Second aerobic | MBR reactor 230 |
|---|---|---|---|
| | reactor (mg/L) | reactor (mg/L) | (mg/L) |
| Na | 33.06 | 38.84 | 55.28 |
| Mg | 7.02 | 17.62 | 23.24 |
| Al | 0.08 | 3.87 | 4.13 |
| Si | 8.73 | 11.29 | 24.61 |
| P | 11.91 | 7.62 | 5.25 |
| S | 4.94 | 11.62 | 15.51 |
| Cl | 0 | 0.45 | 0.68 |
| K | 18.53 | 48.81 | 66.53 |
| Ca | 22.15 | 54.15 | 69.22 |
| Mn | 0.16 | 1.83 | 2.33 |
| Fe | 0.09 | 0.10 | 0.14 |
| Ni | 0 | 0.01 | 0.03 |
| Cu | 0.02 | 0.04 | 0.07 |
| Zn | 0.24 | 7.28 | 10.17 |
| Rb | 0.03 | 0.19 | 0.23 |
| Sr | 0.18 | 0.45 | 0.60 |
| Zr | 0.02 | 0.10 | 0.11 |
| Ba | 1.93 | 6.29 | 6.84 |

In addition, the increase in the rate of degradation of sludge has a close connection with the concentration of nitrate nitrogen. When sludge is degraded, the concentration of ammonia nitrogen in the sludge is increased, and nitrifying microorganisms convert ammonia nitrogen into nitrate nitrogen using oxygen. Thus, when the rate of degradation of sludge is increased, the concentration of nitrate nitrogen in the sludge is also increased, and the concentration of nitrate nitrogen is higher in the order of the first aerobic reactor 210, the second aerobic reactor 220 and the MBR reactor 230.

Meanwhile, the MBR reactor 230 serves to receive the effluent from the second aerobic reactor 220 and biologically remove a high concentration of organic matter from the effluent by the action of aerobic microorganisms while removing total suspended solids (SS) using a membrane. The effluent from the second aerobic reactor is separated into concentrated sludge and effluent by the membrane. The concentrated sludge is returned to the second aerobic reactor 220, and the effluent from the MBR reactor is supplied to the microalgae cultivation apparatus 300.

As described above, in the MBR reactor 230, as the rate of degradation of sludge reaches the peaks, the concentration of nitrate nitrogen also reaches the peak, and thus effluent discharged from the MBR reactor 230 contains a high concentration of nitrate nitrogen. The high concentration to of nitrate nitrogen contained in the effluent increases the efficiency with which microalgae are cultivated. Meanwhile, the concentrated sludge separated by the membrane is returned to the second aerobic reactor 220 and subjected to a degradation process in the second aerobic reactor 220.

In the first aerobic reactor 210, the second aerobic reactor 220 and the MBR reactor 230, the process for reducing the amount of sludge is performed. The concentration of nitrate nitrogen in sludge is increased through each of the reactors, and finally effluent containing a high concentration of nitrate nitrogen can be discharged from the sludge treatment apparatus.

Hereinafter, the microalgae cultivation apparatus 300 will be described. The microalgae cultivation apparatus 300 comprises a microalgae cultivation reactor 310 and a microalgae membrane 320. The microalgae cultivation reactor 310 serves to cultivate microalgae using as nutrient the effluent supplied from the MBR reactor 230 of the sludge treatment apparatus, that is, the effluent containing a high concentration of nitrate nitrogen, and the microalgae membrane 320 serves to separate water in the microalgae cultivation reactor into microalgae and treated water.

The microalgae cultivation reactor 310 may further comprise an aeration device serving to supply carbon dioxide (CO₂) required for the cultivation of microalgae and to prevent the contamination of the microalgae membrane 320. In addition, a light source for supplying light energy required to the cultivation of microalgae can be disposed above the microalgae cultivation reactor.

The configuration and operation of the sludge treatment apparatus 200 and the microalgae cultivation apparatus 300 have been described above. Hereinafter, the advanced sewage treatment apparatus 100 that supplies sludge to the sludge treatment apparatus 200 will be described.

As the advanced sewage treatment apparatus 100, any advanced sewage treatment apparatus can be applied. In other words, the advanced sewage treatment apparatus 100 may be any advanced sewage treatment apparatus serving to treat sewage/wastewater and discharge sludge. For example, the advanced sewage treatment apparatus 100 can be configured to comprise an anaerobic reactor, first and second intermittent aeration reactors which are alternately operated, and a sedimentation tank, so that it can treat a supernatant and discharge sludge. The present disclosure provides an embodiment of an advanced sewage treatment apparatus 100, which can treat a supernatant and discharge sludge while having high biological treatment efficiency and operating efficiency.

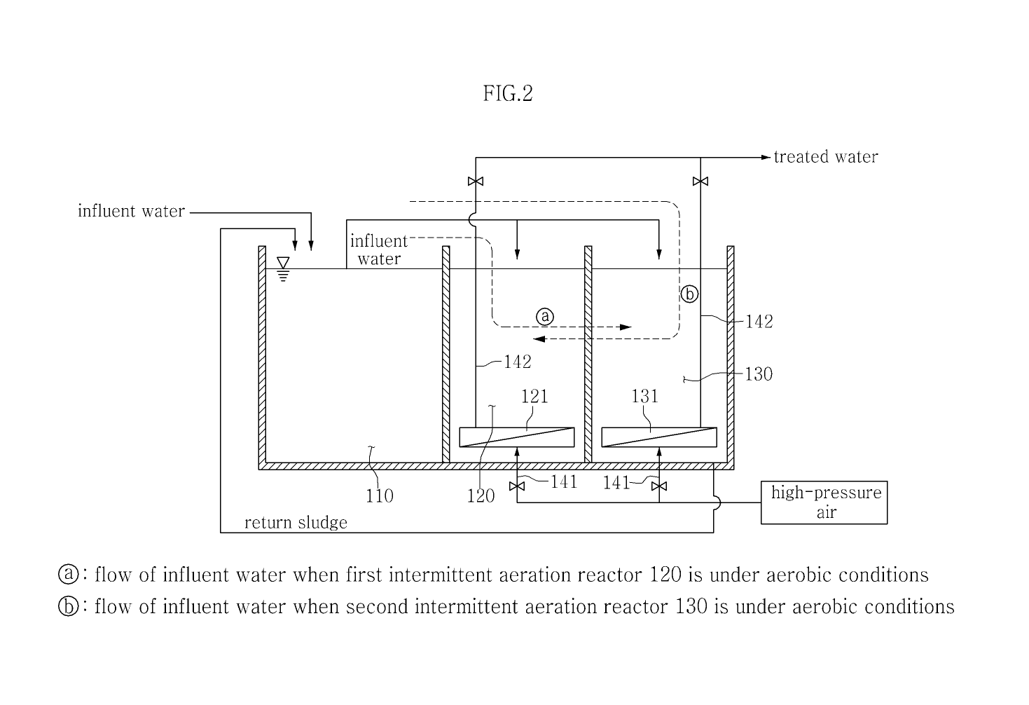

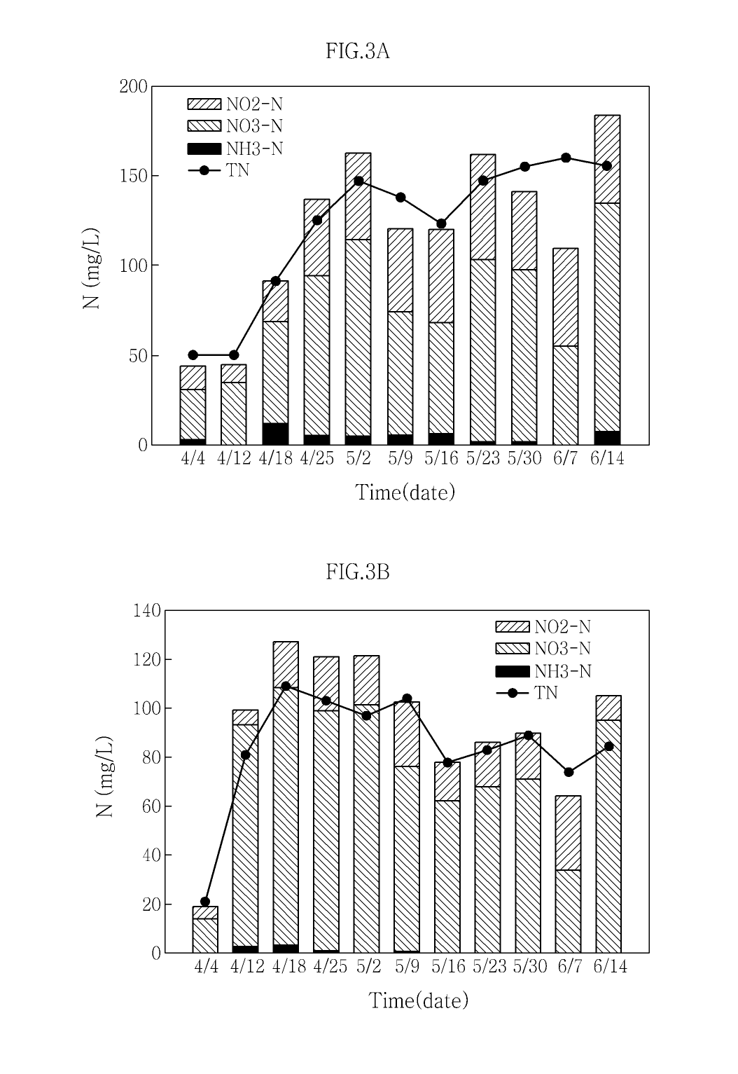

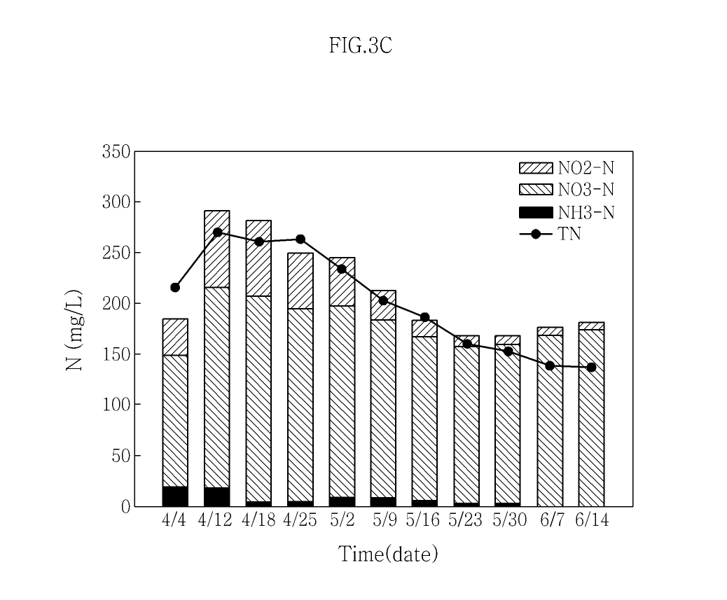

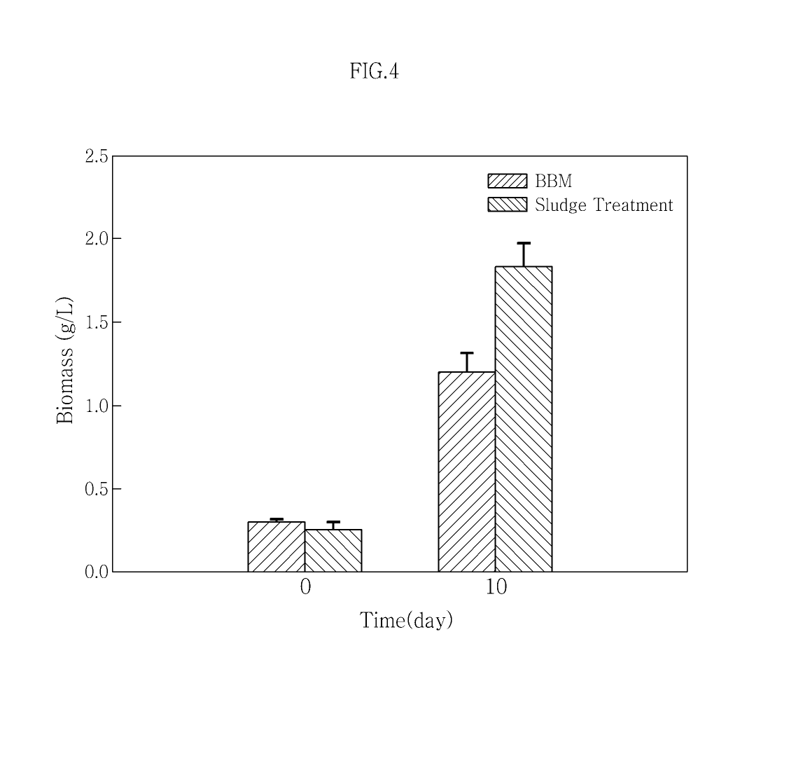

Referring to FIGS. 1 and 2, an advanced sewage treatment apparatus 100 according to an embodiment of the present disclosure comprises an anaerobic reactor 110, a first intermittent aeration reactor 120 and a second intermittent aeration reactor 130. In addition, the first intermittent aeration reactor 120 includes a first ceramic membrane 121, and the second intermittent aeration reactor 130 includes a second ceramic membrane 131.

The anaerobic reactor 110 serves to remove phosphorus (P) from the influent water and denitrify nitrite nitrogen and nitrate nitrogen. The influent water that is introduced into the anaerobic reactor 110 includes externally introduced sewage/wastewater and a sludge returned from the second intermittent aeration reactor 130. The anaerobic reactor 110 includes an agitator and can achieve anaerobic conditions by controlling dissolved oxygen concentration and oxidation-reduction potential by agitation. Herein, the operation of the anaerobic reactor 110 is preferably performed for about 1-2 hours.

Each of the first intermittent aeration reactor 120 and the second intermittent aeration reactor 130 is operated alternately under aerobic conditions and oxygen-free conditions. Under aerobic conditions, these aeration reactors serve to convert organic nitrogen and ammonia nitrogen to nitrite nitrogen and nitrate nitrogen and allow phosphorus in the influent water to be taken by phosphorus-storing microorganisms, and under oxygen-free conditions, these aeration reactors serve to reduce nitrite nitrogen and nitrate nitrogen to nitrogen gas. A portion of the sludge produced by the operation of the second intermittent aeration reactor 130 is returned to the anaerobic reactor 110, and the remaining sludge is supplied to the aeration reactor of the sludge treatment apparatus 200.

The first intermittent aeration reactor 120 and the second intermittent aeration reactor 130 are operated under different conditions. In other words, when the first intermittent aeration reactor 120 is operated under aerobic conditions, the second intermittent aeration reactor 130 is operated under oxygen-free conditions, and on the contrary, when the first intermittent aeration reactor 120 is operated under oxygen-free conditions, the second intermittent aeration reactor 130 is operated under aerobic conditions.

The first intermittent aeration reactor 120 and the second intermittent aeration reactor 130 receive the influent water from the anaerobic reactor 110 and perform the functions as described above. Depending on the operating conditions of the first intermittent aeration reactor 120 and the second intermittent aeration reactor 130, the pathway through which the influent water from the anaerobic reactor 110 is supplied changes.

Specifically, influent water from the anaerobic reactor 110 is supplied only to the intermittent aeration reactor that is operated under aerobic conditions. For example, when the first intermittent aeration reactor 120 is operated under aerobic conditions and the second intermittent aeration reactor 130 is operated under oxygen-free conditions, influent water from the anaerobic tank 110 is supplied only to the first intermittent aeration reactor 120, stays in the first intermittent aeration reactor 120 for a certain time, and then is supplied to the second intermittent aeration reactor 130 (see FIG. 2\textcircled{a}). On the other hand, when the first intermittent aeration reactor 120 is operated under oxygen-free conditions and the second intermittent aeration reactor 130 is operated under aerobic conditions, influent water from the anaerobic reactor 110 is supplied to the second intermittent aeration reactor 130, stays in the second intermittent aeration reactor 130 for a certain time, and then is supplied to the first intermittent aeration reactor 120 (see FIG. 2\textcircled{b}). In to other words, when the first intermittent aeration reactor 120 is operated under aerobic conditions, the influent water moves from the anaerobic reactor 110 through the first intermittent aeration reactor 120 to the second intermittent aeration reactor 130, and when the second intermittent aeration reactor 130 is operated under aerobic conditions, the influent water moves from the anaerobic tank 110 through second intermittent aeration reactor 130 to the first intermittent aeration reactor 120.

Conventional methods employing two intermittent aeration reactors are methods of treating and discharging influent water regardless of operating conditions (aerobic or oxygen-free conditions), and thus influent water can also be supplied to the intermittent aeration reactor that is operated under oxygen-free conditions, and in this case, treatment of the influent water under aerobic conditions will necessarily be insufficient.

According to the present disclosure, influent water from the anaerobic reactor 110 is supplied only to the intermittent aeration reactor that is operated under aerobic conditions, after which it is treated under aerobic conditions for a certain time, and then supplied to the intermittent aeration reactor that is operated under oxygen-free conditions. Thus, the influent water from the anaerobic reactor 110 is treated under both aerobic conditions and oxygen-free conditions, and thus phosphorus intake, nitrification and denitrification processes can be uniformly performed.

The process in which influent water from the anaerobic reactor 110 moves to and stays in the first (or second) intermittent aeration reactor, and the process in which the influent water from the first (or second) intermittent aeration reactor moves to and stays in the second (or first) intermittent aeration reactor are preferably performed during the process in which the first (or second) intermittent aeration reactor is operated under aerobic conditions (or oxygen-free conditions). In addition, the residence time of the influent water in the first intermittent aeration reactor 120 or the second intermittent aeration reactor 130 can be controlled depending on the property of the influent water. In an embodiment, the operation under aerobic conditions and the operation under oxygen-free conditions may each be performed for about 30 minutes to 1 hour.

As described above, the first ceramic membrane 121 and the second ceramic membrane 131, which are of immersion type, are provided in the lower portions of the first intermittent aeration reactor 120 and the second intermittent aeration reactor 130, respectively. Each of the first ceramic membrane 121 and the second ceramic membrane 131 functions to filter influent water to produce treated water. Depending on the conditions in which the first intermittent aeration reactor 120 and the second intermittent aeration reactor 130 are operated, the functions of the first ceramic membrane 121 and the second ceramic membrane 131 change.

In other words, when the first (or second) intermittent aeration reactor is operated under oxygen-free conditions, the first (or second) ceramic membrane discharges treated water, and when the first (or second) intermittent aeration reactor is operated under aerobic conditions, the discharge of treated water from the first (or second) ceramic membrane is stopped, and the influent water is aerated by the first (or second) ceramic membrane.

For this, each of the first ceramic membrane 121 and the second ceramic membrane 131 is provided with an air injection line 141 and a treated-water discharge line 142. The air injection line 141 serves to inject air into the first (or second) ceramic membrane so as to allow the first (or second) intermittent aeration reactor to be under aerobic conditions, and the treated water discharge line 142 serves to discharge treated water produced by the first (second) ceramic membrane to the outside.

Thus, when the first (second) intermittent aeration reactor is under aerobic conditions, air is injected into the first (or second) ceramic membrane through the air supply line 141 to maintain the first (second) intermittent aeration reactor in aerobic conditions, and in this case, the treated-water discharge line 142 is maintained in a closed state. On the contrary, when the first (or second) intermittent aeration reactor is under oxygen-free conditions, the injection of air through the air injection line 141 is blocked so that the first (or second) intermittent reactor is maintained in an oxygen-free state, and treated water produced by the first (or second) ceramic membrane is discharged to the outside through the treated-water discharge line 142. According to this configuration, any one of the first ceramic membrane 121 and the second ceramic membrane 131 discharges treated water, and thus treated water can be continuously produced for 24 hours. Separately from the discharge of treated water, the sludge in the second intermittent aeration reactor is supplied to the aeration reactor of the sludge treatment apparatus, and a portion of the sludge is returned to the anaerobic reactor.

Meanwhile, the first ceramic membrane 121 and the second ceramic membrane 131 are made of a ceramic material such as alumina (Al₂O₃) or zirconia (ZrO₂) and include formed therein pores having a size of 0.01-0.1 μm. Thus, when high-pressure air is supplied to the first (or second) ceramic membrane through the air injection line 141, the pores formed in the ceramic membrane function as a kind of aeration tube to supply air to the intermittent aeration reactor. Thus, a separate aeration tube for air injection is not required. Further, as high-pressure air is injected into the first (or second) ceramic membrane, the effect of washing the ceramic membrane can be obtained in addition to the aeration effect. In a conventional art, backwash water (treatment water) is used to wash the membrane, and thus the efficiency with which treated water is produced is reduced, whereas the present disclosure makes it possible to solve this problem.

Hereinafter, the characteristics of microalgae cultivation in the apparatus for cultivating microalgae using effluent from sludge treatment according to the present disclosure will be described. Table 2 below show the results of analysis of effluent from the sludge treatment apparatus of the present disclosure, and Table 3 below shows the degree of contamination of microalgae cultivated according to the present disclosure and the degree of contamination of microalgae cultivated using conventional media. In addition, FIG. 4 is a graphic diagram showing a comparison between the amount of microalgae cultivated according to the present disclosure and to the amount of microalgae cultivated using conventional media.

As can be seen in Table 2 below, effluent discharged from the sludge treatment apparatus of the present disclosure contained 55 mg/L (on a BOD basis), 157 mg/L of nitrogen, and 3 mg/L of phosphorus, suggesting that microalgae sufficiently grow in a heterotrophic manner. As can be seen in Table 3 below, the growth of microalgae cultivated according to the present disclosure was about 1.5 times higher than the growth of microalgae cultivated using conventional media, and the degree of contamination with other bacteria was higher in the microalgae cultivated using the conventional media. In addition, as can be seen in FIG. 4, the growth of microalgae cultivated using the microalgae cultivation apparatus of the present disclosure (sludge treatment in FIG. 4) was higher than the growth of microalgae cultivated using conventional media (BBM in FIG. 4).

TABLE 2
Characteristics of effluent from sludge treatment apparatus

| Item (mg/L) | Effluent from sludge treatment |
|---|---|
| BOD | 55 |
| COD | 71 |
| TN | 157 |
| TP | 3 |

TABLE 3
Comparison of characteristics of microalgae cultivation
between present disclosure and conventional art

| | Conventional media | Method of present disclosure |
|---|---|---|
| Dry Weight (g/L) | 1.24 | 1.83 |
| Number of Cells | 3.58 | 5.26 |
| (×10⁵/ml) | | |
| Contamination | 64 × 10⁴ | 25 × 10⁵ |
| (CFU/ml) | | |

What is claimed is:

1. An apparatus for cultivating microalgae using effluent from sludge treatment, the apparatus comprising an advanced sewage treatment apparatus, a sludge treatment apparatus and a microalgae cultivation apparatus,
the sludge treatment apparatus comprising:
a first aerobic reactor which is operated under aerobic conditions and serves to reduce the activity of microorganisms in sludge and ferment the sludge by the fermentation of the microorganisms;
a second aerobic reactor which is operated in a state in which air is injected in an amount larger than that in the first aerobic reactor, and serves to increase the fermentation activity of the microorganisms and degrade the sludge; and
a membrane bio-reactor (MBR) which serves to receive effluent from the second aerobic reactor and biologically remove high-concentration organic matter from the effluent by the action of aerobic microorganisms while removing total suspended solids using a membrane,
wherein the effluent from the second aerobic reactor is separated into concentrated sludge and effluent in the MBR reactor, the effluent from the MBR is supplied to the microalgae cultivation apparatus, the concentrated sludge is returned to the second aerobic reactor, and the concentration of nitrate nitrogen increases in the order of the first aerobic reactor, the second aerobic reactor and the MBR reactor.

2. The apparatus of claim 1, wherein the microalgae cultivation apparatus comprises a microalgae cultivation reactor and a microalgae membrane, in which the microalgae cultivation reactor serves to cultivate microalgae using, as nutrient, the effluent from the MBR reactor of the sludge treatment apparatus, and the microalgae membrane serves to water in the microalgae cultivation reactor into microalgae and treated water.

3. The apparatus of claim 1, wherein the advanced sewage treatment apparatus comprises:
an anaerobic reactor serving to remove phosphorus (P) from influent water while denitrifying nitrite nitrogen and nitrate nitrogen;
a first intermittent aeration reactor and a second intermittent aeration reactor, which are operated under different conditions (aerobic conditions and oxygen-free conditions), serve to convert organic nitrogen and ammonia nitrogen to nitrite nitrogen and nitrate nitrogen under aerobic conditions while allowing phosphorus in influent water to be taken by phosphorus-storing microorganisms, and serve to reduce nitrite nitrogen and nitrate nitrogen into nitrogen gas under oxygen-free conditions; and
a first ceramic membrane and a second ceramic membrane, which are provided in the lower portions of the first intermittent aeration reactor and the second intermittent reactor, respectively, and serve to produce treated water,
wherein the first intermittent aeration reactor and the second intermittent aeration reactor are operated under different conditions, influent water discharged from the anaerobic reactor is supplied to one of the first intermittent aeration reactor and the second intermittent aeration reactor, which is operated under aerobic conditions, and when the first intermittent aeration reactor is under aerobic conditions and the second intermittent aeration reactor is under oxygen-free conditions, air is injected into the first intermittent aeration reactor through the first ceramic membrane to maintain the first intermittent aeration reactor in aerobic conditions while treated water is discharged to the outside through the second ceramic membrane, and sludge in the second intermittent aeration reactor is supplied to the aeration reactor of the sludge treatment apparatus.

4. The apparatus of claim 3, wherein each of the first ceramic membrane and the second ceramic membrane is provided with an air injection line and a treated-water discharge line, in which the air injection line serves to inject air into the first ceramic membrane or the second ceramic membrane, and the treated-water discharge line serves to discharge treated water produced by the first ceramic membrane or the second ceramic membrane to the outside.

5. The apparatus of claim 4, wherein, when the first intermittent aeration reactor or the second intermittent aeration reactor is under aerobic conditions, air is injected into the first ceramic membrane or the second ceramic membrane through the air injection line while the treated-water discharge line is blocked, and when the first intermittent aeration reactor or the second intermittent aeration reactor is under oxygen-free conditions, the injection of air through the air injection line is blocked while treated water produced by the first ceramic membrane or the second ceramic membrane is discharged to the outside.

6. A method for cultivating microalgae using effluent from sludge treatment, the method comprising:
performing an advanced sewage treatment process using an advanced sewage treatment apparatus;
supplying sludge, accumulated in the advanced sewage treatment process, to a first aerobic reactor of a sludge treatment apparatus, and fermenting the slurry under aerobic conditions;
aerobically operating a second aerobic reactor while injecting air in an amount larger than that in the first aerobic reactor to increase the fermentation activity of microorganisms in the sludge and degrade the sludge;
degrading the sludge discharged from the second aerobic reactor using an MBR reactor while separating the sludge into concentrated sludge and effluent; and culturing microalgae using the effluent discharged from the MBR reactor,
wherein, the concentration of nitrate nitrogen increases in the order of the first aerobic reactor, the second aerobic reactor and the MBR reactor.
